(19) United States
(12) Patent Application Publication
(10) Pub. No.: US 2020/0001529 A1
(43) Pub. Date: Jan. 2, 2020

(54) FABRICATION PREDICTION SYSTEM, FABRICATION SYSTEM, INFORMATION PROCESSING APPARATUS, AND FABRICATION PREDICTION METHOD

(71) Applicants: Wataru Sugawara, Saitama (JP); Tsukasa MATSUOKA, Kanagawa (JP); Hiroshi MAEDA, Kanagawa (JP); Yasuaki YOROZU, Kanagawa (JP)

(72) Inventors: Wataru Sugawara, Saitama (JP); Tsukasa MATSUOKA, Kanagawa (JP); Hiroshi MAEDA, Kanagawa (JP); Yasuaki YOROZU, Kanagawa (JP)

(73) Assignee: Ricoh Company, Ltd., Tokyo (JP)

(21) Appl. No.: 16/454,138

(22) Filed: Jun. 27, 2019

(30) Foreign Application Priority Data
Jun. 29, 2018 (JP) 2018-123812

(51) Int. Cl. B29C 64/209; B29C 64/118; G06N 20/00; B29C 64/188

(52) U.S. Cl. CPC B29C 64/209; B29C 64/118; B33Y 10/00; B29C 64/188; G06N 20/00

(57) ABSTRACT

A fabrication prediction system includes processing circuitry configured to acquire fabrication data for each layer and a setting of fabrication condition to fabricate a fabrication object, predict a deformation of the fabrication object for each layer in time series from starting of a fabrication of the fabrication object based on the fabrication data for each layer and the setting of fabrication condition, and calculate correction data for each layer based on the deformation of the fabrication object for each layer in time series.

### CROSS-REFERENCE TO RELATED APPLICATIONS

This patent application is based on and claims priority pursuant to 35 U.S.C. § 119(a) to Japanese Patent Application No. 2018-123812, filed on Jun. 29, 2018 in the Japan Patent Office, the entire disclosure of which is hereby incorporated by reference herein.

### BACKGROUND

### Technical Field

The present disclosure relates to a fabrication prediction, more particularly, to a fabrication prediction system to predict fabrication of a fabrication object, a fabrication system, an information processing apparatus, and a fabrication prediction method.

### Related Art

A fabrication apparatus fabricates a three-dimensional fabrication object based on an input three-dimensional shape model data. The fabrication apparatus uses a melted material to fabricate the fabrication object layer-by-layer. During fabrication of the fabrication object, a shape of the fabrication object is given in a melted state of the material, and the material is solidified during cooling process of the fabrication object. However, in a course of cooling process, shrinkage may occur in the fabrication object. The shrinkage results in differences between a desired shape, that is, model data, and the three-dimensional fabrication object actually fabricated. Thus, attempts are made to predict a fabrication result during fabrication of the fabrication object based on the three-dimensional shape model data.

### SUMMARY

In an aspect of this disclosure, a fabrication prediction system includes processing circuitry configured to acquire fabrication data for each layer and a setting of fabrication condition to fabricate a fabrication object, predict a deformation of the fabrication object for each layer in time series from starting of a fabrication of the fabrication object based on the fabrication data for each layer and the setting of fabrication condition, and calculate correction data for each layer based on the deformation of the fabrication object for each layer in time series.

In another aspect of this disclosure, an information processing apparatus includes processing circuitry configured to acquire fabrication data for each layer and a setting of fabrication condition to fabricate a fabrication object, predict deformation of the fabrication object for each layer in time series from starting of a fabrication of the fabrication object based on the fabrication data for each layer and the setting of fabrication condition, and calculate correction data for each layer based on the deformation of the fabrication object for each layer in time series.

In still another aspect of this disclosure, a fabrication prediction method includes acquiring fabrication data for each layer and a setting of fabrication condition to fabricate a fabrication object, predicting deformation of the fabrication object for each layer in time series from starting of a fabrication of the fabrication object based on the fabrication data for each layer and the setting of fabrication condition, and calculating correction data for each layer based on the deformation of the fabrication object for each layer in time series.

### BRIEF DESCRIPTION OF THE DRAWINGS

The aforementioned and other aspects, features, and advantages of the present disclosure will be better understood by reference to the following detailed description when considered in connection with the accompanying drawings, wherein:

FIG. 1 illustrates an example of a hardware configuration of a fabrication system;

FIG. 2 illustrates an example of a hardware configuration of an information processing apparatus;

FIG. 3 illustrates an example of a hardware configuration of a fabrication apparatus;

FIG. 4 is a block diagram of an example of functional configurations of the information processing apparatus and the fabrication apparatus,

FIG. 5 illustrates a data flow from a creation of a fabrication job to updating and issuance of the fabrication in the fabrication system;

FIGS. 6A to 6C are schematic block diagrams of a data structure of a fabrication job file;

FIGS. 7A to 7G illustrate processes from calculation of shape change in time series to calculation of correction data;

FIGS. 8A to 8F illustrate another calculation method of the correction data.

FIG. 9 is a flow chart of an overall fabrication process when an update of a fabrication job file based on a fabrication prediction is requested;

FIG. 10 illustrates a data flow from issuance of a fabrication job to completion of a fabrication process; and

FIG. 11 illustrates a cloud system that includes fabrication systems and a prediction system in a preferred embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in an analogous manner, and achieve similar results.

Although the embodiments are described with technical limitations with reference to the attached drawings, such description is not intended to limit the scope of the disclosure and all the components or elements described in the embodiments of this disclosure are not necessarily indispensable. As used herein, the singular forms “a”, “an”, and “the” are intended to include the plural forms as well, unless the context clearly indicates otherwise.

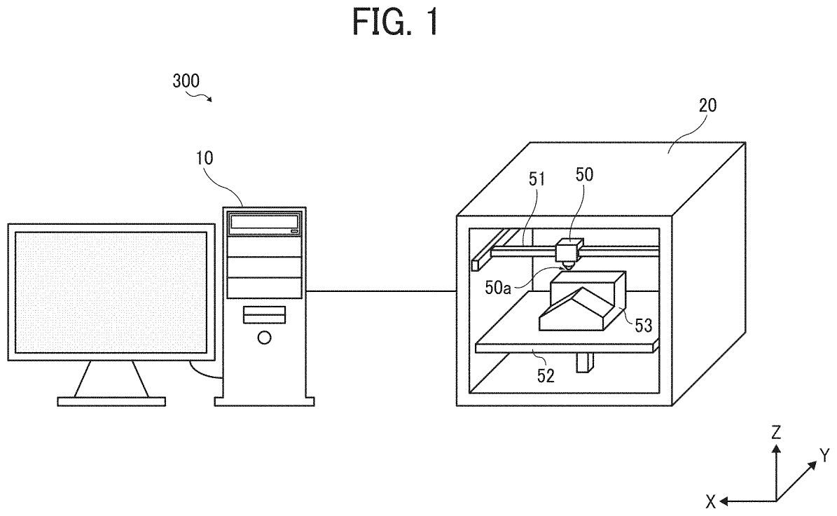

FIG. 1 is a schematic view of an example of a configuration of a fabrication system 300 to fabricate a three-dimensional fabrication object 53. Hereinafter, the “three-dimensional fabrication object 53” is simply referred to as “fabrication object 53”. The fabrication system 300 in FIG. 1 includes an information processing apparatus 10 and a fabrication apparatus 20 to fabricate the fabrication object 53. The information processing apparatus 10 and the fabrication apparatus 20 are connected by wire using a cable, for example, or wirelessly using a wireless LAN (Local Area Network), for example. The information processing apparatus 10 and the fabrication apparatus 20 may be connected via a network.

In the example illustrated in FIG. 1, the fabrication system 300 includes two devices of the information processing apparatus 10 and the fabrication apparatus 20. However, the fabricating system 300 may include one device or three or more devices. For example, the fabrication system 300 may include a function of the information processing apparatus 10 and a fabrication apparatus 20 as a fabrication means to fabricate the fabrication object 53. The function of the information processing apparatus 10 may be distributed to two or more devices, and the fabrication system 300 may include three or more devices including fabrication apparatus 20.

The information processing apparatus 10 transmits fabrication data, as control information to control the fabrication apparatus 20, to the fabrication apparatus 20 as the fabrication means in the present disclosure. The fabrication apparatus 20 receives fabrication data from the information processing apparatus 10 and fabricates the fabrication object 53 based on the fabrication data. The fabrication apparatus 20 includes a fabrication head 50, a guide rod 51, and a stage 52.

The information processing apparatus 10 generates the above-described fabrication data based on three-dimensional shape information (3D data) representing a three-dimensional shape of the fabrication object 53 such as Computer Aided Design (CAD) data created using a program such as CAD and transmits the fabrication data to the fabrication apparatus 20.

At the time of generation of the fabrication data, the information processing apparatus 10 generates, from the 3D data, a plurality of pieces of cross-sectional information representing a cross-sectional shape obtained by cutting (slicing) the fabrication object 53 at predetermined intervals. Then, the information processing apparatus 10 determines a plurality of routes to supply the fabrication material based on the plurality of pieces of cross-sectional information and generates fabrication data based on the route data of the determined plurality of routes.

The fabrication data includes information on from where and to where the fabrication material is supplied, and parameters necessary to fabricate the fabrication object 53, such as temperature at which the resin is melted and a moving speed of the fabrication head 50 as a discharge device. Further, the discharge device is not limited to the fabrication head 50 as long as the material can be supplied (discharge) from the discharge device.

The fabrication apparatus 20 moves the fabrication head 50 along the guide rod 51 in a direction indicated by arrow X (X-direction) in FIG. 1 according to the fabrication data received from the information processing apparatus 10. The fabrication head 50 discharges the fabrication material from a discharge nozzle 50a onto the stage 52, and a layer of the fabrication material is formed and laminated layer-by-layer to fabricate a desired fabrication object 53 on the stage 52.

The fabrication apparatus 20 discharges the fabrication material linearly from the fabrication head 50 while moving the fabrication head 50 along the guide rod 51 in X-direction to fabricate the fabrication object 53. A width of the line-shaped fabrication material discharged from the discharge nozzle 50a of the fabrication head 50 changes according to a diameter of the discharge nozzle 50a of the fabrication head 50, a discharge amount of the fabrication material, and the moving speed of the fabrication head 50.

The fabrication apparatus 20 moves the fabrication head 50 in a two-dimensional direction (XY-direction in FIG. 1) and moves the stage 52 onto which the fabrication object 53 is fabricated in a vertical direction (Z-direction in FIG. 1) to laminate the layers of the fabrication material and fabricate the fabrication object 53. Specifically, the fabrication head 50 moves in the two-dimensional direction (XY-direction) to fabricate one layer, and then the stage 52 is lowered by one step (depth of one layer) to fabricate next layer on the fabricated layer.

The fabrication apparatus 20 is not limited to the embodiment as described above. For example, the stage 52 may move in the XY-direction, and the fabrication head 50 may move in the Z-direction to fabricate the fabrication object 53 onto the stage 52.

The fabrication process using a resin material forms a shape of the fabrication object 53 in a state in which the resin is melted by heat, and the fabrication object 53 is solidified during a cooling process of the fabrication object 53. The fabricated fabrication object 53 shrinks during a cooling process of the fabrication object 53. During the shrinkage of the fabrication object 53, a rate of shrinkage differs with a change of a degree of crystallization of the fabricated fabrication object 53 according to a temperature change or stress applied to the fabrication object 53 when the resin is a crystalline resin.

Further, the shape of the fabricated fabrication object 53 changes with the passage of time after a fabrication process and during the fabrication process of the fabrication object 53. It is described below a technique that improves accuracy of fabrication of the fabrication object 53. The technique predicts a change of the shape of the fabricated fabrication object 53 in each stage during a fabrication process and each point after the fabrication process in time series.

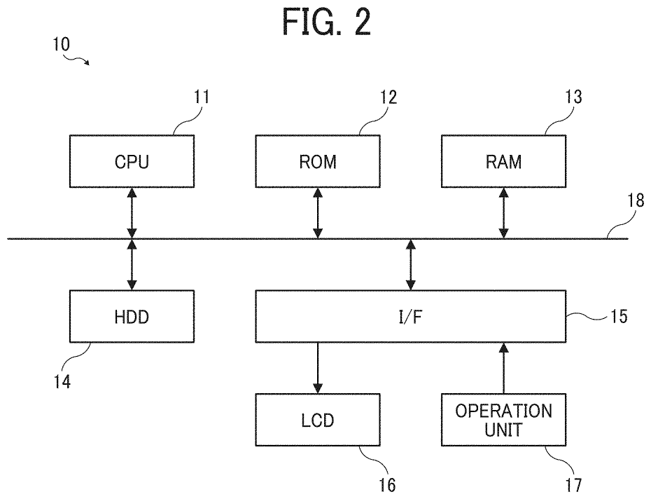

A hardware configuration of the information processing apparatus 10 is described with reference to FIG. 2. The information processing apparatus 10 has the same configuration as a general personal computer. Thus, the information processing apparatus 10 includes a Central Processing Unit (CPU) 11, a Read Only Memory (ROM) 12, a Random-Access Memory (RAM) 13, a Hard Disk Drive (HDD) 14, an interface (I/F) 15, a Liquid Crystal Display (LCD) 16, and an operation unit 17.

The CPU 11, the ROM 12, the RAM 13, the HDD 14, and the I/F 15 are connected to one another via a bus 18. The HDD 14 may be any storage device such as a Solid-State Drive (SSD) as long as the HDD 14 is a non-volatile storage device.

The CPU 11 is an arithmetic means and controls the operation of the entire information processing apparatus 10. The ROM 12 is a read only nonvolatile storage medium and stores a boot program and a program such as firmware to control hardware. The RAM 13 is a volatile storage medium capable of high-speed reading and writing of information and is used as a work area when the CPU 11 processes information. The HDD 14 is a non-volatile storage medium capable of reading and writing information, and stores an operating system (OS), various programs, various data, and the like.

The I/F 15 connects the bus 18 to various types of hardware and networks and controls input and output of information, transmission and reception of information, and the like. The I/F 15 may include a network interface (network I/F) for the information processing apparatus 10 to communicate with other devices via the network. Ethernet (registered trademark), Universal Serial Bus (USB) interface or the like may be used as the network I/F. The LCD 16 is a visual user interface for the user to confirm the state of the information processing apparatus 10. The operation unit 17 is a user interface, such as a keyboard and a mouse, for a user to input information to the information processing apparatus 10.

The information processing apparatus 10 includes functional units that implements various functions by the CPU 11 performing calculations according to a program stored in the ROM 12 and a program read from a storage medium such as the HDD 14 or an optical disk to the RAM 13. The functional unit may be entirely implemented by an execution of a program, partially implemented by the execution of a program, and the other may be implemented by hardware such as a circuit, or all may be implemented by hardware. The CPU 11 is one of an example of processing circuits or circuitry.

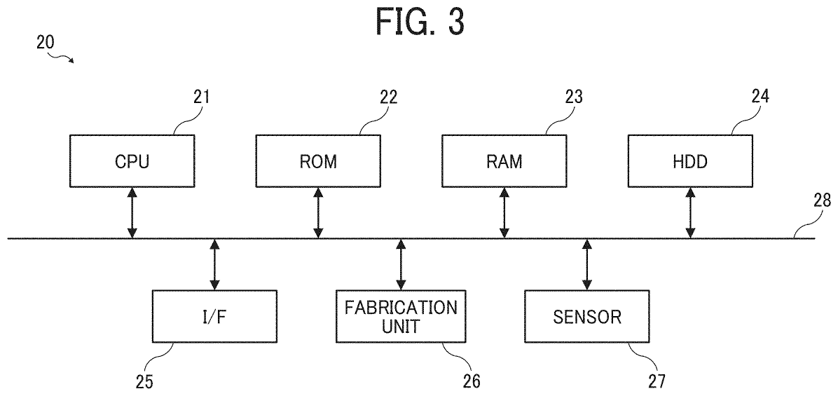

Next, configuration of a hardware of the fabrication apparatus 20 is described with reference to FIG. 3. The fabrication apparatus 20 also includes a CPU 21, a ROM 22, a RAM 23, an HDD 24, and an I/F 25, and further includes a fabrication unit 26, and a sensor 27. The CPU 21, the ROM 22, the RAM 23, the HDD 24, the I/F 25, the fabrication unit 26, and the sensor 27 are connected to one another via the bus 18. The HDD 24 may be any storage device such as an SSD, as long as the storage device is a non-volatile storage device.

The CPU 21 is an arithmetic means and controls the operation of the entire fabrication apparatus 20 to perform predetermined process. The ROM 22 is a read only nonvolatile storage medium and stores a boot program and a program such as firmware to control hardware. The RAM 23 is a volatile storage medium capable of high-speed reading and writing of information and is used as a work area when the CPU 21 processes information. The HDD 24 is a non-volatile storage medium capable of reading and writing information, and stores an operating system (OS), application programs, setting information, and the like. The CPU 21 is one of an example of processing circuits or circuitry.

The I/F 25 connects the bus 28 to various hardware, networks, etc., and controls input and output of information, transmission and reception of information, etc. The I/F 15 may include a network interface (network I/F) for the fabrication apparatus 20 to communicate with other devices via the network. Ethernet (registered trademark), Universal Serial Bus (USB) interface, or the like may be used as the network I/F.

The fabrication unit 26 is a fabrication device to supply (discharge) a fabrication material onto the stage 52 to fabricate a desired fabrication object 53. The fabrication unit 26 includes the fabrication head 50 to supply (discharge) a fabrication material onto the stage 52 and the stage 52 on which the fabrication object 53 is fabricated by the fabrication material discharged from the fabrication head 50. If a Fused Filament Fabrication (FFF) method is adopted as a fabrication method, the fabrication unit 26 includes a heating mechanism or the like to melt the fabrication material. If a Selective Laser Sintering (SLS) method is adopted as a fabrication method, the fabrication unit 26 includes a laser light source or the like.

The sensor 27 is a sensor that measures a shape of a fabrication object 53 during fabrication, or a sensor that measures characteristics of the fabrication object 53, such as temperature. A sensor that measures the shape of the fabrication object 53 measures dimensions and the like in a horizontal direction (X-direction and Y-direction) and a vertical direction (Z-direction) of the fabrication object 53. As a sensor that measures the shape of the fabrication object 53, an infrared sensor, a camera, a 3D scanner, or the like can be used. A sensor such as thermography may be used as a temperature sensor.

The sensor 27 can measure the shape and characteristics of the layer to be fabricated in conjunction with the fabrication operation by the fabrication head 50. Further, the sensor 27 measures the shape and the characteristics of the fabrication object 53 each time when one layer of the fabrication object 53 has been fabricated.

Timing of measurement and a range of measurement of the sensor 27 may be any timing and range as long as the shape and characteristics of the fabricated layer can be measured for each layer of the fabrication object 53.

The sensor 27 may be only a sensor that measures a shape, may be only a sensor that measures a characteristic, or may be a sensor that measures both of the shape and the characteristics. The sensor that measures the characteristics is not limited to the temperature sensor as long as the sensor can measure the characteristics that affects the shrinkage of the fabrication material and may thus be a sensor that measures characteristics other than the temperature.

The fabrication apparatus 20 includes functional units that implement various functions by the CPU 21 performing computations according to programs stored in the ROM 22 and programs read from the storage medium such as the HDD 24 or the SD card into the RAM 23. The functional unit may be entirely implemented by an execution of a program, partially implemented by the execution of a program, and the other may be implemented by hardware such as a circuit, or all may be implemented by hardware.

FIG. 4 is a block diagram of an example of a functional configuration of the information processing apparatus 10 and the fabrication apparatus 20 configuring the fabrication system. The information processing apparatus 10 includes, as a functional unit, a fabrication job generator 30, a fabrication data generator 31, a fabrication prediction unit 32, and a storing unit 34. The fabrication apparatus 20 includes a fabrication unit 41, a measurement unit 42, and preferably a fabrication-data correction unit 43 as a functional unit.

The fabrication unit 41 is a fabrication device to discharge a fabrication material on the stage 52 to fabricate a desired fabrication object 53

Note that the embodiment illustrated in FIG. 4 is one of examples and is not limited to the specific embodiment illustrated in FIG. 4. In another embodiment, a part of functional units (for example, a fabrication-data correction unit 43 or the like) in the fabrication apparatus 20 may be configured on the information processing apparatus 10. In still another embodiment, the function of the information processing apparatus 10 may be distributed to two or more devices and may be configured of three or more devices including the fabrication apparatus 20.

For example, in a specific embodiment, each functional unit of the information processing apparatus 10 may be distributed and mounted on a fabrication apparatus 20, an information processing apparatus 10 connected to the fabrication apparatus 20, and a computer of a cloud system connected to the information processing apparatus 10 via the Internet or the like.

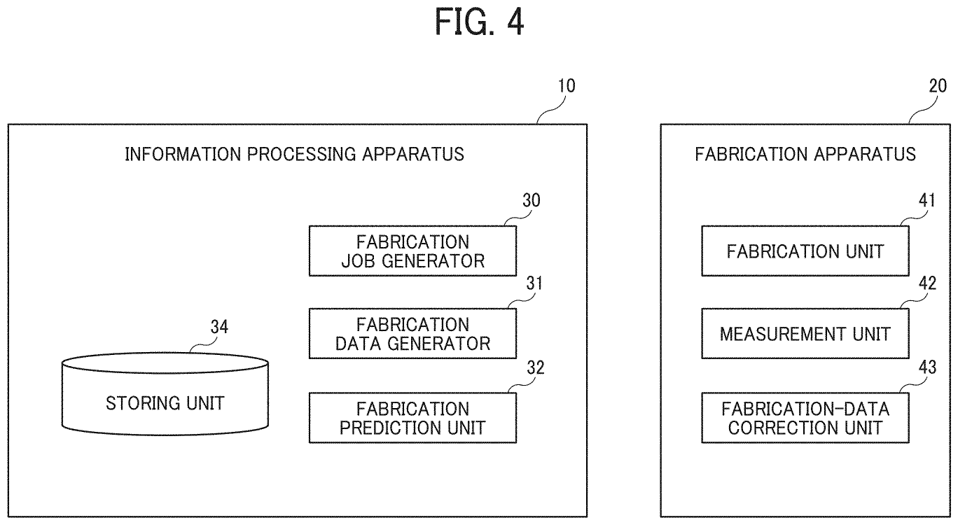

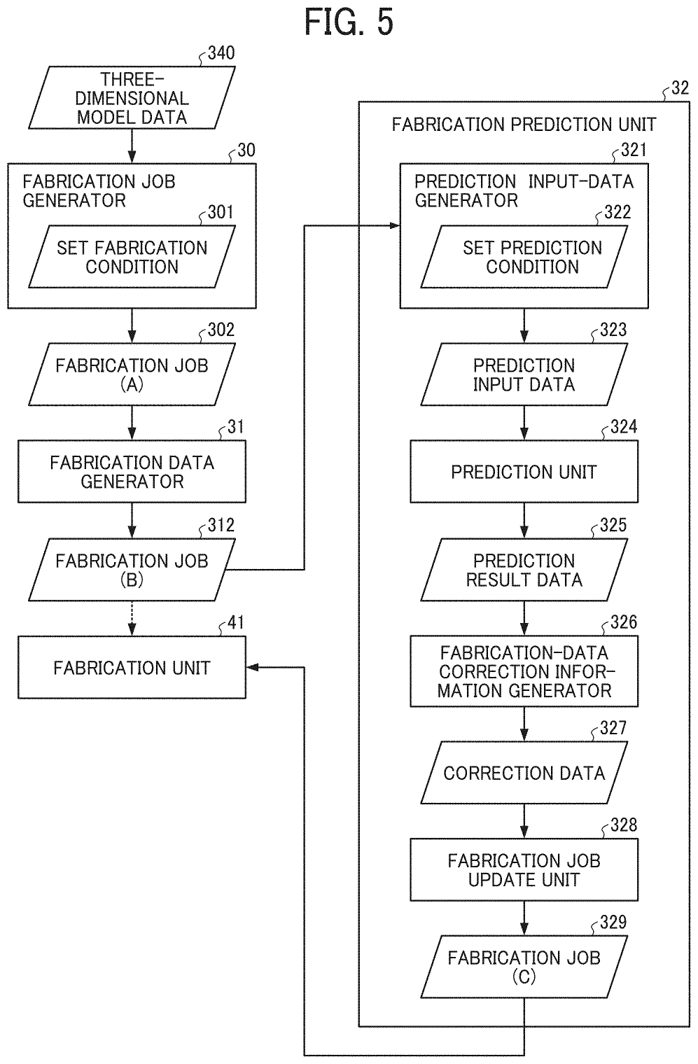

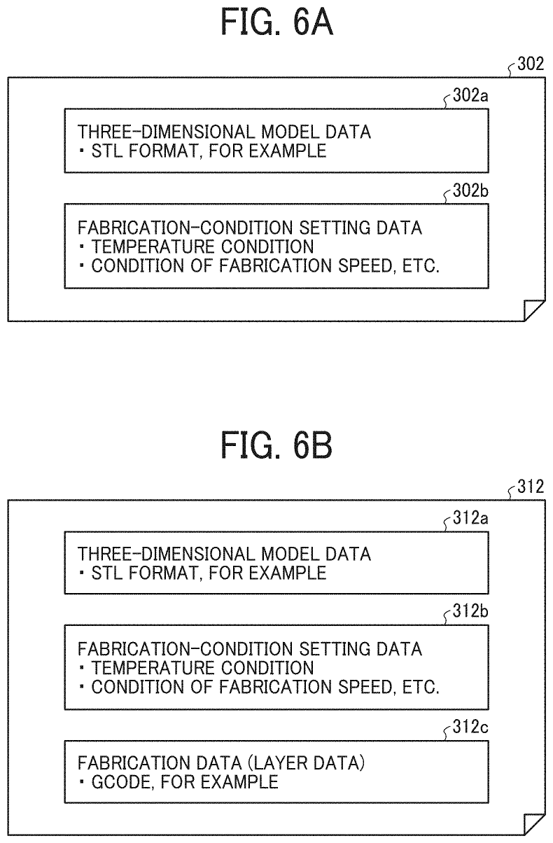

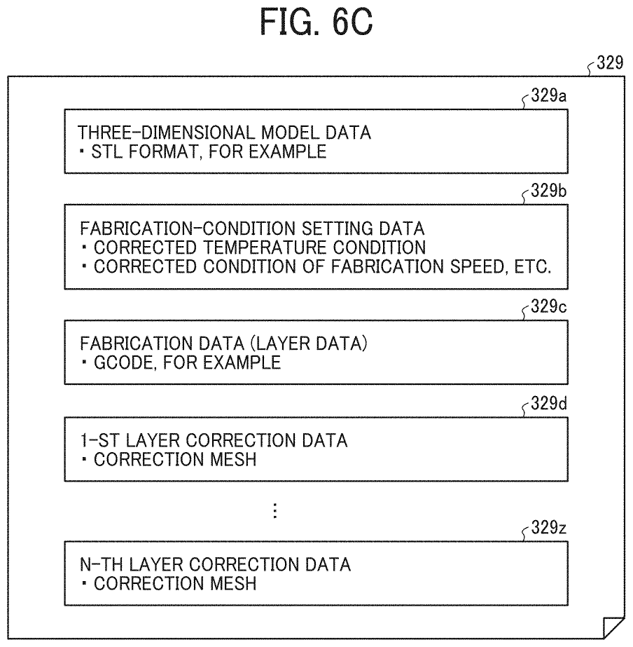

FIG. 5 illustrates a data flow from a creation of a fabrication job to updating and issuance of the fabrication in the present fabrication system. FIGS. 6A to 6C are schematic block diagrams of data structures of fabrication job files. The details of each process performed by each functional unit illustrated in FIG. 4 is described below with reference to FIGS. 5 and 6 together.

The fabrication job generator 30 generates a fabrication job file 302 (hereinafter simply referred to as a “fabrication job (A) 302”) based on three-dimensional (3D) shape model data 340 (hereinafter simply referred to as “model data 340”). The fabrication job generator 30 holds, for example, fabrication-condition setting data 301 according to a fabrication method of the fabrication unit 41. The fabrication-condition setting data 301 is externally set. Further, the fabrication-condition setting data 301 is used to generate the fabrication job (A) 302 in addition to the model data 340 described above. The generated fabrication job (A) 302 is stored in the storing unit 34.

FIG. 6A illustrates a data structure of the fabrication job (A) 302 generated by the fabrication job generator 30 in the present disclosure. The fabrication job file has a container format and is configured to be holdable a plurality of types of data together. The fabrication job (A) 302 generated by the fabrication job generator 30 includes three-dimensional model data 302a and a fabrication-condition setting data 302b.

The three-dimensional model data 302a is identical to the model data 340 as described above. However, the three-dimensional model data 302a is not limited to the model data 340. For example, the three-dimensional model data 302a may be data representing a three-dimensional shape as a collection of graphic units such as small triangles. For example, the three-dimensional model data 302a may include various types of files used in Computer Aided Design (CAD) and Computer Aided Manufacturing (CAM) such as Standard Triangulated Language (STL) files.

The fabrication-condition setting data 302b is identical to the fabrication-condition setting data 301 held by the fabrication job generator 30. The fabrication-condition setting data 302b may include information such as a temperature condition such as a material temperature and an environmental temperature, a condition of a fabrication speed, physical properties such as a melting temperature of a material, and the like.

The data flow is described below with referring to FIG. 5 again. The fabrication data generator 31 reads out the fabrication job (A) 302, renders the three-dimensional model data 302a in the fabrication job (A) 302 based on the fabrication-condition setting data 302b in the fabrication job (A) 302, and generates fabrication data for each layer. The fabrication data generator 31 generates a fabrication job file 312 including the fabrication data 312c for each layer in the fabrication job file (A) 302. Hereinafter, the fabrication job file 312 is also referred to as a fabrication job (B) 312.

The generated fabrication job (B) 312 is stored in the storing unit 34.

FIG. 6B illustrates a data structure of the fabrication job (B) 312 generated by the fabrication data generator 31 in the present disclosure. The fabrication job (B) 312 includes three-dimensional model data 312a, the fabrication-condition setting data 312b, and generated fabrication data 312c. The fabrication data 312c includes layer-by-layer data across a plurality of layers obtained by cutting a three-dimensional shape defined by the three-dimensional model data 312a into slices as described above. For example, the fabrication data 312c may include data of a format such as GCode if the FFF method is adopted as a fabrication method.

When the fabrication job is used as it is as designated by the user, the fabrication job (B) 312 generated by the fabrication data generator 31 is delivered to the fabrication unit 41 as illustrated by arrow in a broken line in FIG. 5. The fabrication unit 41 acquires the fabrication job (B) 312 generated by the fabrication data generator 31 and executes a fabrication operation according to a predetermined fabrication method based on the fabrication-condition setting data 312b and the fabrication data 312c in fabrication job (B) 312 to fabricate the fabrication object 53 having a desired shape.

The fabrication method of the fabrication unit 41 is not particularly limited. The fabrication method may include various methods such as a Fused Filament Fabrication (FFF), a Selective Laser Sintering (SLS), a Material Jetting (MJ), an Electron Beam Melting (EBM), and a Stereolithography Apparatus (SLA).

When update of the fabrication job file based on fabrication prediction is requested, the fabrication job (B) generated by the fabrication data generator 31 is sent to the fabrication prediction unit 32. The fabrication prediction unit 32 predicts a shape of the fabrication object 53 to be fabricated when the model data 340 is used to fabricate the fabrication object 53 according to set fabrication conditions. FIG. 5 illustrates a specific configuration of the fabrication prediction unit 32. As illustrated in FIG. 5, the fabrication prediction unit 32 according to the present disclosure includes a prediction input-data generator 321, a prediction unit 324, a fabrication-data correction information generator 326, and a fabrication job update unit 328.

The information processing apparatus 10 including the fabrication prediction unit 32 is one example of a fabrication prediction system. The functions of the fabrication prediction unit 32 are executed by the CPU 11 in the information processing apparatus 10.

The prediction input-data generator 321 acquires the fabrication job (B) 312 sent to the fabrication prediction unit 32. The prediction input-data generator 321 holds prediction-condition setting data 322. The prediction-condition setting data 322 includes constraint point information to calculate prediction, a temperature condition setting, and information related to simulation such as whether to perform parallel calculation in simulation and number of CPU cores and threads to be used to perform the parallel calculation. The prediction-condition setting data 322 may be defined inside the program or may be set from the outside the program.

The prediction input-data generator 321 creates prediction input data 323 based on the prediction-condition setting data 322 held by the fabrication-condition setting data 312b and the fabrication data 312c in the fabrication job (B) and also held by the prediction input-data generator 321. The prediction input data 323 is an input face processable by the prediction unit 324. The prediction input data 323 has a container format, and includes model data 340, fabrication-condition setting data 301, fabrication data 312c, and prediction-condition setting data 322, for example. The generated prediction input data 323 is stored in the storing unit 34. The prediction input-data generator 321 configures an acquisition unit according to the present disclosure.

There are various fabrication methods such as FFF, SLS, MJ, EBM, and SLA as described above. In a particular embodiment, the prediction input data 323 may have a common format that may be used as input data for a plurality of simulation methods according to the corresponding fabrication method.

The prediction unit 324 models the temperature change of the material discharged in the fabrication process and the accompanying shrinkage, a generation of internal stress, a change in the structure, and the like. The prediction unit 324 predicts a shape of the fabrication object 53 to be fabricated and a deformation of the shape of the fabricated fabrication object 53 with passage of time when the model data 340 is used to fabricate the fabrication object 53 by a predetermined fabrication method based on a fabrication condition previously set.

More specifically, the prediction unit 324 predicts a deformation of the fabrication object 53 for each layer in time series during fabrication after starting fabrication of the fabrication object 53 and after the fabrication of the fabrication object 53 based on the fabrication-condition setting data 312b in the prediction input data 323, the prediction-condition setting data 322, and the fabrication data 312c to generate prediction result data 325. The generated prediction result data 325 is stored in the storing unit 34.

In particular embodiments, the prediction unit 324 may include a plurality types of simulation method. There are various fabrication methods such as FFF, SLS, MJ, EBM, and SLA as described above. Thus, a simulation method appropriate to each different fabrication method is prepared (selected) from the plurality of simulation methods. Further, there may be more than one analytical calculation method for the same fabrication method. A different simulation method may be prepared for each combination of the fabrication method and an analytical calculation method. The prediction unit 324 according to the specific embodiment selects the simulation method corresponding to the predetermined fabrication method among the plurality of simulation methods.

Further, the prediction unit 324 inputs the prediction input data 323 and acquires the deformation of the fabrication object 53 for each layer in time series as prediction result data 325. Here, one simulation method corresponding to a predetermined fabrication method is selected. When there is a plurality of analytical calculation methods, one simulation method corresponding to the specified analytical calculation method is selected.

The prediction unit 324 in the present disclosure includes the plurality of simulation methods. However, the prediction unit 324 is not limited to include the plurality of simulation methods. When the fabrication method of the fabrication unit 41 is fixed to a specific method (fabrication method and analytical calculation method), the prediction unit 324 may include one or more simulation method according to the corresponding fabrication method that corresponds to the type of the analysis calculation method. The prediction unit 324 constitutes a prediction unit according to the present disclosure.

In the above-described description, the prediction unit 324 performs the simulation in the information processing apparatus 10 including the fabrication prediction unit 32 as illustrated in FIGS. 4 and 5. However, a device to perform the simulation is not limited to the embodiments as described above, and the simulation may be performed by a unit other than information processing apparatus 10. In other embodiments, some or all of the simulation operations may be performed on another computer system.

The prediction unit 324 sends the prediction input data 323 to a simulation unit on another computer system and receives the prediction result data 325 as a simulation result from the simulation unit on another computer system. Further, an amount of residual stress may be calculated in the simulation in addition to the shape of the fabrication object 53. It is described in detail below a prediction of deformation of the fabrication object 53 for each layer in time series during and after the fabrication of the fabrication object 53 by the prediction unit 324.

The fabrication-data correction information generator 326 calculates correction data (correction information) for each layer with respect to fabrication data based on the deformation of the fabrication object 53 for each layer in time series calculated by the prediction unit 324. Here, the correction data for each layer can be information that controls a discharge process of the material by the fabrication unit 41. Further, changing the setting of the fabrication condition may reduce the deformation of the fabrication object according to the result of simulation.

The fabrication-data correction information generator 326 can calculate a corrected setting of a fabrication condition based on a deformation of the fabrication object 53 for each layer in time series, preferably together with or instead of calculation of the correction data. The fabrication-data correction information generator 326 constitutes a calculation unit in the present disclosure. It is described below in detail a generation of the correction information based on the deformation of the fabrication object 53 for each layer in time series during and after the fabrication of the fabrication object by the fabrication-data correction information generator 326.

The fabrication job update unit 328 adds calculated correction data for each layer to the fabrication job (B) 312 sent from the fabrication-data correction information generator 326 or updates the fabrication-condition setting data 312b in the fabrication job (B) 312 sent from the fabrication data generator 31 by a corrected setting of the fabrication condition or performs both of adding and updating as described above. Thus, an updated fabrication job file (C) 329 is generated. Hereinafter, the fabrication job file (C) 329 is also simply referred to as a “fabrication job (C) 329”. The fabrication job (B) 312 is also referred to as “a first fabrication job”, and the fabrication job (C) 329 is also referred to as “a second fabrication job”.

FIG. 6C illustrates a data structure of a fabrication job (C) 329 updated by the fabrication job update unit 328 in the present disclosure. The fabrication job (C) 329 updated by the fabrication job update unit 328 includes three-dimensional model data 329a, updated fabrication-condition setting data 329b, fabrication data 329c, and calculated correction data 329d to 329z for each layer. The updated fabrication-condition setting data 329b includes, for example, a corrected temperature condition, a corrected condition of fabrication speed, and the like.

Referring back to FIG. 5, the updated fabrication job (C) 329 is sent to the fabrication unit 41. That is, when it is requested to update the fabrication job file based on the fabrication prediction, the fabrication job (B) 312 generated by the fabrication data generator 31 is sent to the fabrication prediction unit 32, and is updated as described above, and is then sent to the fabrication unit 41 as illustrated by a solid line in FIG. 5.

The fabrication unit 41 acquires fabrication job (B) 312 updated by the fabrication job update unit 328 and executes a fabrication operation according to a predetermined fabrication method based on the updated fabrication-condition setting data 329b, the fabrication data 329c, and the correction data 329d to 329z for each layer in the fabrication job (B) to fabricate a fabrication object 53 having a desired shape.

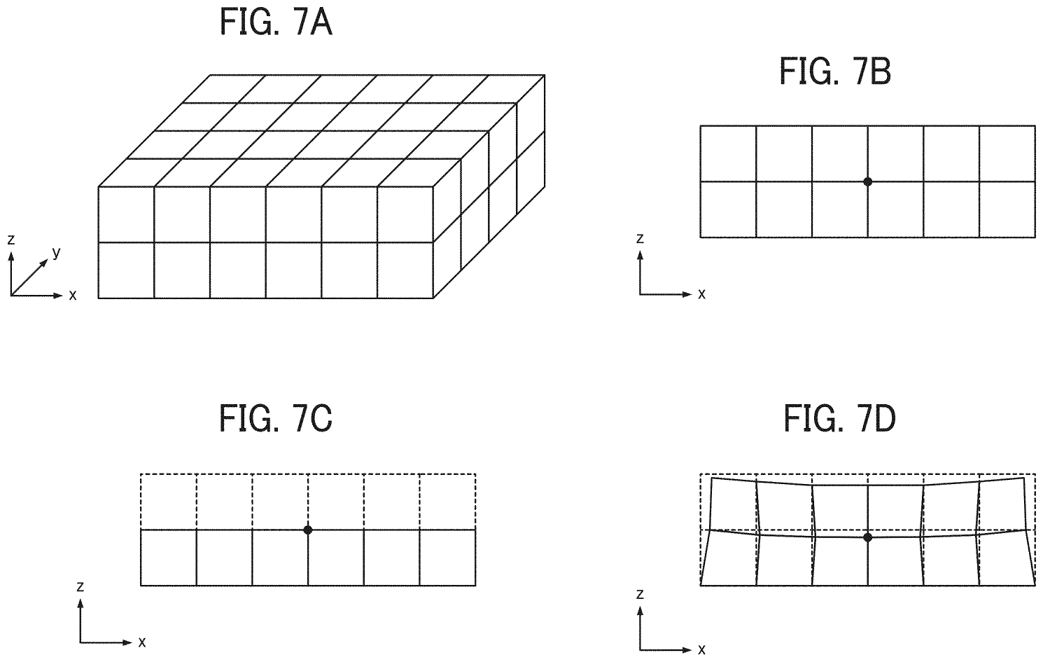

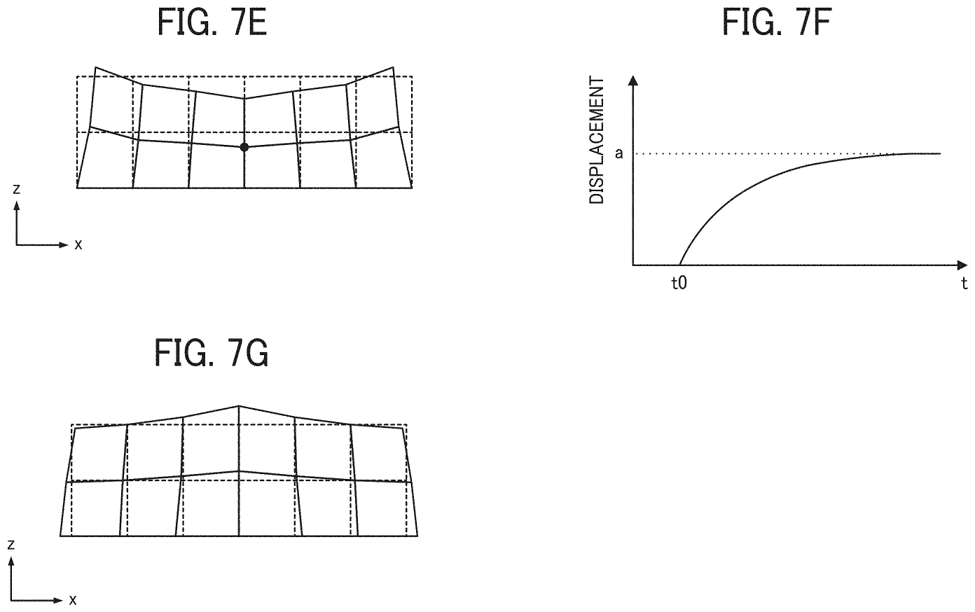

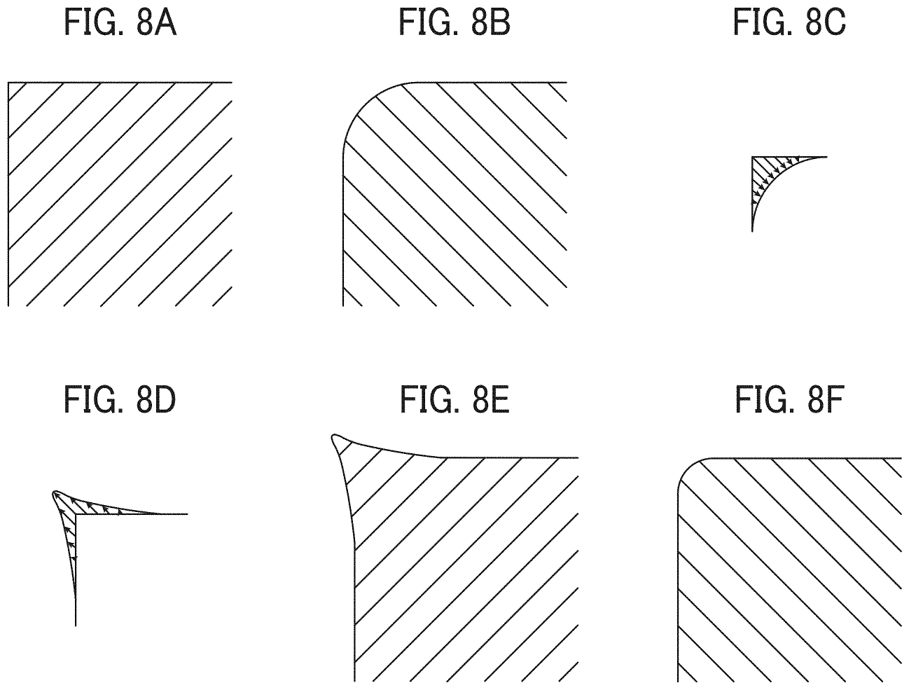

It is described below in detail the prediction of the shape changes in the fabrication object 53 for each layer in time series performed by the prediction input-data generator 321 illustrated in FIG. 4 and a calculation method of the correction data 327 based on the predicted shape change for each layer in time series with reference to FIG. 7 and FIG. 8. FIGS. 7A to 7G illustrate processes from calculation of deformation (shape change) for each layer in time series to calculation of correction data.

The prediction unit 324 first converts the three-dimensional model data 329a into a form of a set of hexahedron meshes as illustrated in FIG. 7A and generates a reference shape that is an ideal shape of the fabrication object 53 to be fabricated. Here, the reference shape is represented by a set of hexahedrons of substantially uniform size, and a height of the hexahedron mesh typically corresponds to a thickness of one layer of lamination of the fabrication object 53. The deformation of the fabrication object 53 for each layer in time series during and after the fabrication of the fabrication object 53 can be calculated as deformation of positional coordinates from the reference shape at each vertex of hexahedron meshes during and after the fabrication of the fabrication object 53 at multiple time points. The hexahedron mesh is one of a three-dimensional mesh (solid mesh), and the present disclosure may use other types of the three-dimensional mesh (solid mesh) such as tetrahedron mesh.

Here, the prediction result data can be expressed as data obtained by converting model data into a hexahedron mesh. Thus, unlike the three-dimensional model data that expresses a three-dimensional shape as a surface of a fabrication object 53 constituted by an aggregation of figure units such as small triangles, the prediction result data also holds information of deformation inside the three-dimensional model data.

As a deformation of the fabrication object 53 for each layer in time series to be stored, for example, predicted deformation of the fabrication object 53 for each fabricated layer in time series at each time when the fabrication of each layer has been completed is stored during fabrication of the fabrication object 53. After the fabrication of the fabrication object 53, a predicted deformation of the fabrication object 53 for each layer in time series is stored. Each layer constitutes an entire fabrication object 53 at any given time after the fabrication of the fabrication object 53.

Here, it is described below an example of a three-dimensional shape represented as a set of hexahedron meshes in a ZYZ axis coordinate system as illustrated in FIG. 7A. FIG. 7B is a cross-sectional view along a ZX plane when the three-dimensional shape is observed from the Y-axis direction. In FIG. 7B, one vertex to be focused in the hexahedron mesh is illustrated by a black circle.

FIG. 7C illustrates a predicted shape when a first layer is laminated. The first layer that has already been fabricated is indicated by a solid line, and a second layer to be fabricated on the first layer is indicated by a broken line.

FIG. 7D illustrates a predicted shape of the fabrication object 53 when the second layer is laminated (fabricated). The solid line indicates a predicted shape of the fabricated first layer and the second layer. The broken line indicates a reference shape of the first layer and the second layer.

FIG. 7E illustrates a predicted shape after t-time has elapsed since a completion of the fabrication of the fabrication object 53. The solid line indicates an actual predicted shape of the fabricated first layer and the second layer. The broken line indicates a reference shape of the first layer and the second layer.

When a position of the vertex indicated by a black circle in FIGS. 7C to 7E is focused, the position coordinate simply changes with time as illustrated as a “displacement” in FIG. 7F. Here, it is assumed that a movement of the coordinate (displacement) of the vertex illustrated by a black circle converges after an elapse of time “t” after the fabrication the fabrication object 53 corresponding to FIG. 7E.

Then, a difference between the reference shape illustrated by the broken line in FIG. 7E and a predicted deformed shape after the elapse of the time “t” illustrated by the solid line is considered. A deformation to reduce a deformation of the fabrication object 53 or reverse deformation is applied to an original reference shape to control the fabrication of the fabrication object 53 to have a shape as illustrated in FIG. 7G. Thus, in a state of convergence of the deformation of the fabrication object 53 illustrated in FIG. 7G, it is possible to finally obtain a fabrication object 53 having an ideal reference shape.

Thus, the fabrication-data correction information generator 326 generates data to control a discharge amount of material that implements the fabrication as illustrated in FIG. 7G. The hexahedron mesh calculated as illustrated in FIG. 7G is referred to as a “correction mesh”. A portion corresponding to each layer of the correction mesh becomes the correction data for each layer. Further, a shape by the fabrication is again predicted using the calculated correction mesh. Then, a calculation of the correction mesh may be repeated until the difference between the reference shape and the predicted deformed shape becomes within an allowable range.

FIGS. 8A to 8F illustrate another method of correcting the fabrication data. In the above description with reference to FIGS. 7A to 7G, the deformation in the XZ plane including a moving direction of the stage 52 (Z-axis direction) is mainly described. FIGS. 8A to 8F illustrate, for example, a method of correcting the fabrication data with respect to deformation in the XY plane in which the discharge nozzle 50a of the fabrication head 50 is scanned in the FFF method, for example.

FIG. 8A illustrates an example of fabrication data. For easier understanding of a change in a shape of a three-dimensional fabrication object 53, the fabrication object 53 is illustrated here in a two-dimensional shape. In the fabrication data, a shape of the fabrication object is rectangular, and corners of the fabrication object are angular such as approximately 90 degrees. FIG. 8A illustrates a part of the fabrication data.

FIG. 8B illustrates a result of setting the fabrication conditions and predicting the deformation to fabricate the shape illustrated in FIG. 8A. The corners are rounded as a result of prediction.

FIG. 8C illustrates how a shape of the fabrication object 53 changes. The shape change of the fabrication object 53 illustrated in FIG. 8C is obtained by comparing the fabrication data of FIG. 8A with the result of the prediction of FIG. 8B. Arrows in FIG. 8C are deformation vectors each indicating a direction of deformation and a magnitude of deformation.

FIG. 8D illustrates an example of a correction method. The correction method inverts the above-described deformation vector in FIG. 8C, keeps the magnitude of the deformation (magnitude of the deformation vector) unchanged, and rotates (inverts) a direction of deformation by 180 degree to obtain the correction vector as illustrated in FIG. 8D. The above-described correction method is applied to the fabrication data as illustrated in FIG. 8B. Note that the above examples are only one of examples, and the present disclosure is not limited to the examples described above.

FIG. 8E illustrates the fabrication data corrected by applying the correction vector as illustrated in FIG. 8D. As a result of the application of the correction vector, the corner that most greatly shrinks is corrected to a shape that greatly protrudes from the corner as illustrated in FIG. 5E.

FIG. 8F illustrates a shape prediction data in which a deformation is predicted when a fabrication object is fabricated based on corrected fabrication data. The shape prediction data predicts a shape of the fabricated object. As illustrated in FIG. 8F, there is still a rounded portion in the corner of the fabrication object 53.

However, the size of the rounded portion is decreased compared to the rounded portion in FIG. 8B by an effect of the correction of the fabrication data as illustrated in FIGS. 8D and 8E. The rounded portion in the corner of the fabrication object 53 is regarded as an error, and it is determined whether the error is within an allowable range. If the error is within the allowable range, the corrected fabrication data is used as the fabrication data after correction, and fabrication of the fabrication object is performed using the corrected fabrication data.

Conversely, if the error is out of the allowable range, the fabrication data as illustrated in FIG. 8A is compared with the shape prediction data after correction as illustrated in FIG. 8F to obtain a deformation vector. Then, a correction vector is obtained from the deformation vector. The correction vector is further applied to the fabrication data after correction illustrated in FIG. 8E to correct the fabrication data. The above-described process is repeated until the error becomes within the allowable range.

As described above, the correction method according to the present disclosure repeats generation of the correction data and a prediction of a deformation of a shape of the fabrication object during a fabrication process based on the correction data to enable an optimization of the fabrication data.

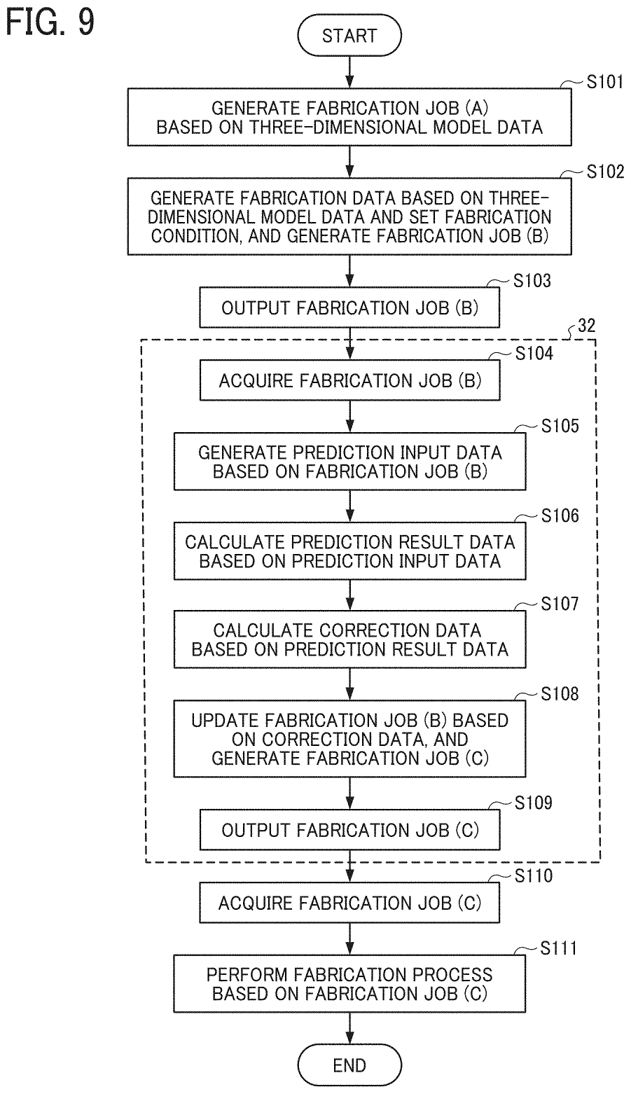

FIG. 9 illustrates a flow of an entire fabrication process when an update of a fabrication job file based on a fabrication prediction is requested in the present disclosure. The process illustrated in FIG. 9 is started from step S100 in response to an instruction to start fabrication process including optimization. The model data is designated by the operator in the instruction to start fabrication process.

In step S101, the fabrication job generator 30 generates a fabrication job file (A) 302 based on the model data 340.

In step S102, the fabrication data generator 31 generates fabrication data based on the fabrication-condition setting data 302b and the three-dimensional model data 302a in the fabrication job (A) 302 and generates a fabrication job (B) 312.

In step S103, the fabrication data generator 31 outputs the fabrication job (B) 312 to the fabrication prediction unit 32.

In step S104, the prediction input-data generator 321 acquires the fabrication job (B) 312 sent from the fabrication data generator 31.

In step S105, the prediction input-data generator 321 generates prediction input data 323 based on the fabrication job (B) 312.

In step S106, the prediction unit 324 predicts a deformation of the fabrication object 53 for each layer in time series during and after starting the fabrication process of the fabrication object 53 based on the prediction input data 323 and generates (calculates) prediction result data 325.

In step S107, the fabrication-data correction information generator 326 calculates either or both of the correction data of the fabrication data for each layer and the updated fabrication-condition setting data based on the deformation of the fabrication object for each layer in time series calculated by the prediction unit 324.

In step S108, the fabrication job update unit 328 generates the updated fabrication job (C) 329 from the fabrication job (B) 312 sent from the fabrication data generator 31 based on the correction information such as the correction data for each layer and the updated fabrication-condition setting data.

In step S109, the fabrication job update unit 328 outputs the updated fabrication job (C) 329 to the fabrication unit 41.

In step S110, the fabrication apparatus 20 acquires the updated fabrication job (C) 329.

In step S111, the fabrication apparatus 20 executes a fabrication process based on the updated fabrication job (C) 329 and ends the fabrication process (END).

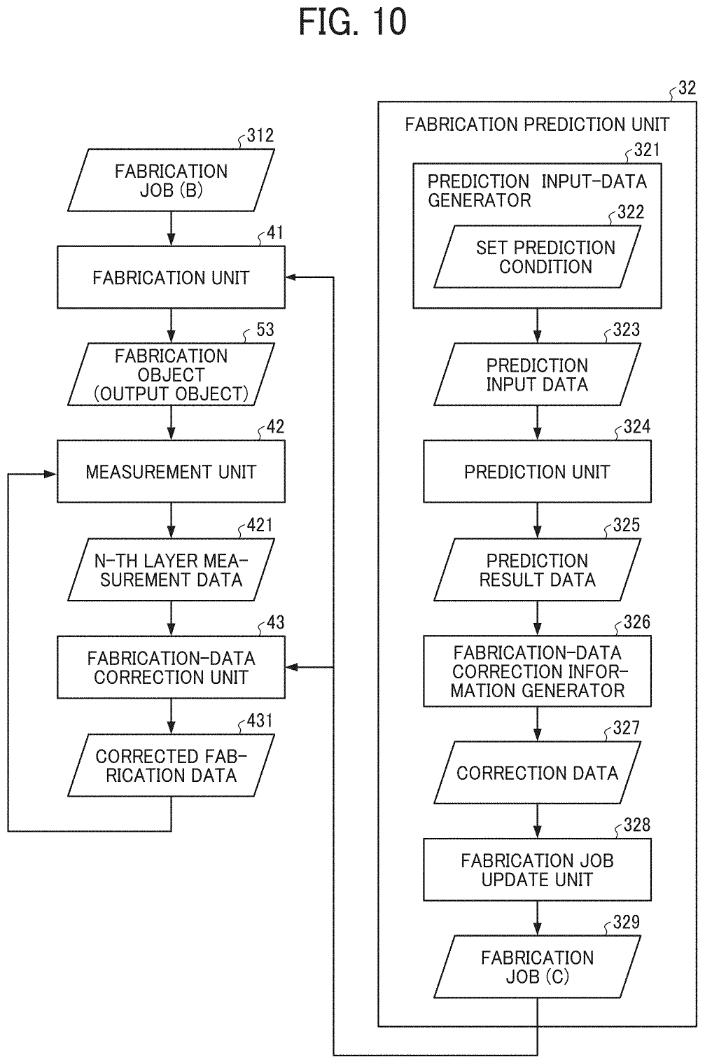

The fabrication process using the updated fabrication job (C) 329 is described with reference to FIG. 10. FIG. 10 illustrates a data flow from issuance of a fabrication job to completion of a fabrication process. The fabrication unit 41 acquires the updated fabrication job (C) 329 from the fabrication prediction unit 32.

The fabrication unit 41 supplies (discharges) a fabrication material on the stage 52 from the discharge nozzle 50a of the fabrication head 50 based on the fabrication data for each layer of the fabrication object in the fabrication job (C) 329, the fabrication-condition setting data 329b (updated appropriately), the fabrication data 329c for each layer and the correction data 329d to 329z for each layer. The fabrication unit 41 executes the fabrication process of the fabrication object 53 for each layer.

The fabrication unit 41 can control the fabrication process for each layer according to the fabrication data based on the correction data during the fabrication process of the fabrication object 53. Here, the fabrication process performed by the fabrication unit 41 is changed based on the correction data. Parameters and algorithm included in the fabrication data may be changed to change the fabrication process.

As an example of the parameters in the fabrication data includes a shape of the fabrication object 53 to be fabricated, a dimension and a height of each fabrication layer, a fabrication amount based on fabrication data, melting temperature of the fabrication material, a fabrication speed, a lamination pitch, and the like.

The fabrication unit 41 controls the fabrication process based on the fabrication data using the correction data to optimize a drawing method of each layer when the fabrication object 53 is actually fabricated. The drawing method controls discharge pressure of the fabrication material from the fabrication head 50, the drawing speed of the fabrication head 50, and so on.

For example, the fabrication unit 41 controls the fabrication process based on the fabrication data to perform the fabrication process as illustrated in FIG. 7G. Thus, the fabrication system 300 according to the present disclosure can fabricate a fabrication object 53 that finally becomes an ideal shape when the shrinkage of the fabrication object 53 is converged.

In a specific embodiment, the fabrication apparatus 20 may further include a measurement unit 42 and a fabrication-data correction unit 43 in addition to the fabrication unit 41. The measurement unit 42 measures a shape of a fabrication object 53 (output object) at time of fabrication of each layer fabricated by the fabrication unit 41 and generates N-th layer measurement data 421.

The fabrication-data correction unit 43 corrects fabrication data of a next layer and subsequent layers based on the N-th layer measurement data 421 to create a corrected fabrication data 431 as illustrated in FIG. 10. The fabrication-data correction unit 43 can correct the fabrication data of the next layer and the subsequent layers based on the correction data for each layer in the fabrication job (C) 329.

More specifically, the fabrication-data correction unit 43 can correct the fabrication data based on the fabrication data and the predicted shape predicted from the correction data 327. Further, the fabrication-data correction unit 43 compares a measurement shape of an output object (fabrication object 53) measured by the measurement unit 42 with a predicted shape predicted based on the fabrication data and the correction data.

The output object (fabrication object 53) is fabricated based on the fabrication data and the correction data. Thus, the fabrication-data correction unit 43 can calculate a prediction error that indicates a difference between the measured shape and the predicted shape. The prediction performed by the fabrication-data correction unit 43 is the same as the prediction performed by the fabrication prediction unit 32 as described above. The prediction result data 325 of deformation at each point of fabrication process may be inquired to the fabrication prediction unit 32. The calculated prediction error is an amount indicating how much the measurement result (measured shape) is different from the predicted shape.

The fabrication-data correction unit 43 can update a simulation model as described above so that prediction errors such as an error in the predicted shape can be reduced. Then, prediction of the next layer is performed based on the updated model data. Thus, the measurement result (measured shape) at the time of fabrication of each layer of the fabrication object 411 by the measurement unit 42 is reflected to correct the fabrication data of the subsequent layer. Thus, the fabrication system 300 can accurately fabricate the fabrication object 411.

In the above-described embodiment, a correction method is performed to improve accuracy of fabrication of the fabrication object 411. As the correction method, the discharge pressure of the fabrication material, the drawing speed, and the like is optimized for the fabrication data of each layer based on the correction mesh of each layer, for example.

However, the correction method is not limited to the embodiment as described above, and any correction method that can reflect the correction information can be used. The correction information includes the correction data for each layer based on the deformation of the fabrication object 53 for each layer in time series. In another embodiment, the model data is reconstructed based on the correction mesh.

The model data takes a factor of the deformation of the fabrication object 53 during and after the fabrication process into consideration. The reconstructed model data is sliced to regenerate the fabrication data, and the regenerated fabrication data may be used to fabricate the fabrication object 53.

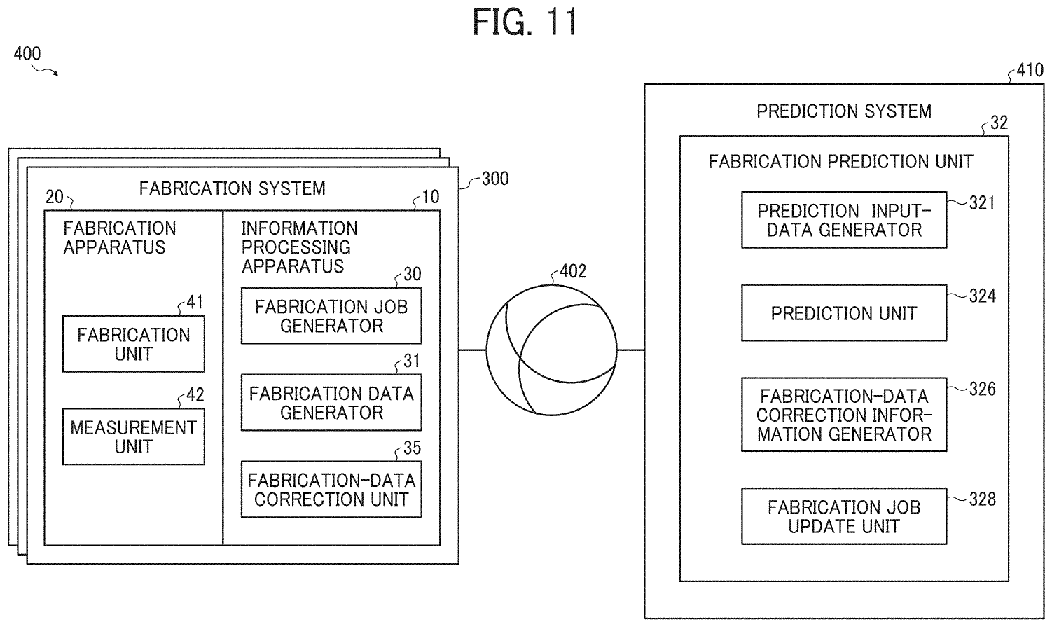

As described above, a specific embodiment is used to describe the fabrication system 300 in which the deformation of the fabrication object 53 in time series is predicted and is reflected to the fabrication process with reference to FIGS. 1 to 10. Next, a preferred embodiment that provides a fabrication prediction and a correction function commonly used to a plurality of fabrication systems is described below with reference to FIG. 11.

FIG. 11 illustrates a cloud system 400 that includes a plurality of fabrication systems 300 and a prediction system 410 in a preferred embodiment.

As illustrated in FIG. 11, The cloud system 400 includes the plurality of fabrication systems 300 and the prediction system 410 connected to the plurality of fabrication systems 300 via the Internet 402. Each of the plurality of fabrication systems 300 includes a fabrication apparatus 20, to which a predetermined fabrication method is adopted, and an information processing apparatus 10.

The prediction system 410 is another example of the fabrication prediction system.

In the present embodiment, the fabrication apparatus 20 includes a fabrication unit 41 and a measurement unit 42. Further, the information processing apparatus 10 includes a fabrication job generator 30, a fabrication data generator 31, and a fabrication-data correction unit 35.

The prediction system 410 of the cloud-side includes a fabrication prediction unit 32. Similarly to the embodiment as described with reference to FIGS. 1 to 10, the fabrication prediction unit 32 includes a prediction input-data generator 321, a prediction unit 324, a fabrication-data correction information generator 326, and a fabrication job update unit 328. The function of each parts is the same as the function of the embodiments as described with reference to FIGS. 1 to 10 unless otherwise described.

The fabrication prediction unit 32 in the information processing apparatus 10 as illustrated in FIG. 4 is provided on the prediction system 410 of the cloud-side in the embodiment illustrated in FIG. 11. The prediction system 410 in the present disclosure provides a function of predicting a shape of a fabrication object 53 to be fabricated commonly to a plurality of fabricating systems 300 as a cloud service.

The plurality of fabricating systems 300 can adopt different types of fabrication methods. The present embodiment is described as providing a function of predicting a shape of the fabrication object 53 as a cloud service. However, the present embodiment is not necessarily limited to the cloud service.

The above-described embodiments can provide a fabrication prediction system, an information processing apparatus, a program, and a fabrication prediction method capable of predicting deformation of a fabrication object in time series after starting fabrication of the fabrication object and generating an optimized correction information.

Each function of the above-described embodiments of the present disclosure can be realized by a device executable program described by C, C++, C#, Java (registered trademark), etc. The program of the present disclosure is storable and distributable to the device readable recording media such as a hard disk drive (HDD), a compact disc read only memory (CD-ROM), a magneto-optic disk (MO), a digital versatile disc (DVD), a flexible disk, an electrically erasable and programmable read only memory (EEPROM), an erasable programmable read-only memory (EPROM), or can be transmitted via a network in a format readable by other devices.

Although several embodiments of the present disclosure have been described above, embodiments of the present disclosure are not limited to the above-described embodiments, and various modifications may be made without departing from the spirit and scope of the present disclosure. Such modifications are included within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

Numerous additional modifications and variations are possible in light of the above teachings. Such modifications and variations are not to be regarded as a departure from the scope of the present disclosure and appended claims, and all such modifications are intended to be included within the scope of the present disclosure and appended claims.

What is claimed is:

1. A fabrication prediction system comprising processing circuitry configured to:
acquire fabrication data for each layer and a setting of fabrication condition to fabricate a fabrication object;
predict a deformation of the fabrication object for each layer in time series from starting of a fabrication of the fabrication object based on the fabrication data for each layer and the setting of fabrication condition; and
calculate correction data for each layer based on the deformation of the fabrication object for each layer in time series.

2. The fabrication prediction system according to claim 1,
wherein the processing circuitry calculates to correct the setting of fabrication condition based on the deformation of the fabrication object for each layer in time series to generate a corrected setting of fabrication condition.

3. The fabrication prediction system according to claim 2,
wherein the processing circuitry acquires the fabrication data for each layer and the setting of fabrication condition as a first fabrication job, and
the processing circuitry performs at least one of:
adding the correction data for each layer to the first fabrication job; and
updating the setting of fabrication condition in the first fabrication job with the corrected setting of fabrication condition,
to generate a second fabrication job.

4. The fabrication prediction system according to claim 1,
wherein the processing circuitry predicts a reference shape of the fabrication object in a form of a set of three-dimensional meshes, and
the processing circuitry calculates the deformation that includes a deformation of positional coordinates from the reference shape at each vertex of the set of three-dimensional meshes during and after the fabrication of the fabrication object at multiple time points.

5. A fabrication prediction system according to claim 1,
wherein the processing circuitry:
compares the fabrication data for each layer with the deformation of the fabrication object for each layer in time series to calculate a deformation vector indicating a direction of deformation and magnitude of deformation;
inverts the direction of deformation of the deformation vector while keeping the magnitude of deformation of the deformation vector unchanged to obtain a correction vector; and
applies the correction vector to the fabrication data for each layer to generate the correction data for each layer.

6. The fabrication prediction system according to claim 1,
wherein the processing circuitry:
creates input data having a common format for a plurality of simulation methods according to a plurality of fabrication methods based on the fabrication data for each layer and the setting of fabrication condition;
selects a simulation method corresponding to a predetermined fabrication method among the plurality of simulation methods; and
predicts the deformation of the fabrication object for each layer in time series based on the fabrication data for each layer and the setting of fabrication condition in the input data to generate prediction result data.

7. A fabrication system comprising:
the fabrication prediction system according to claim 3; and
a fabrication device configured to fabricate the fabrication object layer-by-layer based on the fabrication data for each layer,
wherein the processing circuitry
measures a shape of the fabrication object at time of fabrication of each layer of the fabrication object by the fabrication device; and
corrects the fabrication data of subsequent layers based on the shape of the fabrication object measured and the correction data for each layer in the second fabrication job.

8. The fabrication system according to claim 7,
wherein the fabrication device discharges a material layer-by-layer to fabricate the fabrication object, and
the correction data for each layer includes information to control a discharge process of the material by the fabrication device.

9. An information processing apparatus comprising processing circuitry configured to:
acquire fabrication data for each layer and a setting of fabrication condition to fabricate a fabrication object;
predict deformation of the fabrication object for each layer in time series from starting of a fabrication of the fabrication object based on the fabrication data for each layer and the setting of fabrication condition; and
calculate correction data for each layer based on the deformation of the fabrication object for each layer in time series.

10. A fabrication prediction method comprising:
acquiring fabrication data for each layer and a setting of fabrication condition to fabricate a fabrication object;
predicting deformation of the fabrication object for each layer in time series from starting of a fabrication of the fabrication object based on the fabrication data for each layer and the setting of fabrication condition; and
calculating correction data for each layer based on the deformation of the fabrication object for each layer in time series.
